(19) United States
(12) Patent Application Publication
(10) Pub. No.: US 2014/0071250 A1
(43) Pub. Date: Mar. 13, 2014

(54) DESKTOP THREE-DIMENSIONAL IMAGE SCANNER

(71) Applicant: PRIMAX ELECTRONICS LTD., Neihu (TW)

(72) Inventors: Yung-Tai Pan, Taipei (TW); Chien-Kuo Kuan, Taipei (TW); Li-Cheng Sun, Taipei (TW); Wei-Guo Deng, Taipei (TW)

(73) Assignee: PRIMAX ELECTRONICS LTD., Taipei (TW)

(21) Appl. No.: 13/737,603

(22) Filed: Jan. 9, 2013

(30) Foreign Application Priority Data
Sep. 7, 2012 (CN) 201210329864.9

(51) Int. Cl. H04N 13/02

(52) U.S. Cl. CPC H04N 13/0221
USPC 348/50

(57) ABSTRACT

A desktop three-dimensional image scanner is provided for producing a humanoid vision-based three-dimensional image. The desktop three-dimensional image scanner includes an image pickup device and a position-limiting mechanism. The position-limiting mechanism is used for fixing the image pickup device at a first shooting position or a second shooting position. A spacing distance between the first shooting position and the second shooting position is in a range between 6 and 70 millimeters. An included angle between an optical axis of the image pickup device at the first shooting position and the optical axis of the image pickup device at the second shooting position is in a range between 1 and 30 degrees.

### FIELD OF THE INVENTION

The present invention relates to an image scanner, and more particularly to a desktop three-dimensional image scanner

### BACKGROUND OF THE INVENTION

Generally, an image scanner is mainly used for capturing images. By using a plane scanning process to scan a planar article (e.g. a paper or a document), the contents of the planar article can be converted into an electronic file. The electronic file may be further transmitted, managed or stored by the user. With the maturity of scanning technologies, image scanners have experienced great growth and are now rapidly gaining in popularity.

Recently, an image scanner especially designed for scanning a three-dimensional article has been disclosed. FIG. 1 is a schematic side view illustrating a conventional desktop three-dimensional image scanner. FIG. 2 is a schematic front view illustrating the conventional desktop three-dimensional image scanner of FIG. 1 and taken along a viewpoint V1. The conventional desktop three-dimensional image scanner 9 as shown in FIGS. 1 and 2 is disclosed in for example U.S. Pat. No. 5894529. The desktop three-dimensional image scanner 9 comprises a base 92 and a CCD (charge couple device) sensor 91. A three-dimensional object 8 (e.g. a car model) is placed on the base 92. During operations of the CCD sensor 91, the CCD sensor 91 is moved from a position D3 to another position D4 to scan the three-dimensional object 8 in order to acquire the entire top-view image of the three-dimensional object 8.

Furthermore, during the CCD sensor 91 is moved from the position D3 to the position D4, the direction of the optical axis L9 is kept unchanged. That is, during the CCD sensor 91 is moved from the position D3 to the position D4, the optical axes L9 corresponding to different positions are always parallel with each other. Consequently, there is no included angle between the optical axes L9 of the CCD sensor 91 corresponding to any two positions. In other words, the use of the conventional desktop three-dimensional image scanner 9 is able to acquire the planar image of the three-dimensional object 8, but unable to acquire a three-dimensional image of the three-dimensional object 8.

For solving the above drawbacks, another method for acquiring the three-dimensional image of the three-dimensional object has been disclosed. In accordance with this method, an image pickup device is employed to shoot the three-dimensional object from multiple different viewpoints in a surround mode. For example, the portions from a front side of the three-dimensional object to a rear side of the three-dimensional object are shot by the image pickup device, and thus multiple different planar images are acquired. Since there is an included angle between the optical axes of the image pickup device corresponding to any two positions, after an image processing operation is performed on the multiple different planar images, the three-dimensional image of the three-dimensional object may be obtained. Since the obtained three-dimensional image is a full view three-dimensional image, the entire image of the front, rear, right and left sides of the three-dimensional object can be completely watched. The above method for acquiring the three-dimensional image of the three-dimensional object is well-known to those skilled in the art, and is not redundantly described herein.

As known, the conventional method for acquiring the three-dimensional image of the three-dimensional object is usually adopted to shoot a scene (e.g. shoot a movie). Moreover, since it is necessary to shoot the three-dimensional object many times in the surround mode, the conventional method for acquiring the three-dimensional image needs a large operating space. Moreover, in some special applications, it is unnecessary to shoot the three-dimensional object from too many viewpoints. For example, in the experiment applications or the inspection applications, the use of the image pickup device to shoot the three-dimensional object from only some specified viewpoints is sufficient to acquire the acceptable three-dimensional image. In addition, it is desired to obtain the three-dimensional image of the three-dimensional object in a simplified operating manner. However, there is still no technology and product that meet the above requirements.

### SUMMARY OF THE INVENTION

The present invention relates to an image scanner, and more particularly to a desktop three-dimensional image scanner

In accordance with an aspect of the present invention, there is provided a desktop three-dimensional image scanner. The desktop three-dimensional image scanner includes an image pickup device and a position-limiting mechanism. The image pickup device is located over an object for shooting the object at a first shooting position and a second shooting position, thereby acquiring a first planar image and a second planar image, respectively. The position-limiting mechanism is used for accommodating the image pickup device and fixing the image pickup device at the first shooting position or the second shooting position. A humanoid vision-based three-dimensional image of the object is produced according to the first planar image and the second planar image. A spacing distance between the first shooting position and the second shooting position is in a range between 6 and 70 millimeters. Moreover, an included angle between an optical axis of the image pickup device at the first shooting position and the optical axis of the image pickup device at the second shooting position is in a range between 1 and 30 degrees.

In an embodiment, the desktop three-dimensional image scanner further includes an image processing unit for processing the first planar image and the second planar image, thereby producing the humanoid vision-based three-dimensional image.

In an embodiment, the desktop three-dimensional image scanner is in communication with an electronic device. The electronic device includes an image processing unit for processing the first planar image and the second planar image, thereby producing the humanoid vision-based three-dimensional image.

In an embodiment, the desktop three-dimensional image scanner further includes a placement platform. The object is placed on the placement platform.

In an embodiment, the desktop three-dimensional image scanner further includes a supporting stand. The supporting stand is connected between the placement platform and the position-limiting mechanism.

In an embodiment, the position-limiting mechanism includes a guiding slot. The first shooting position and the second shooting position are located at a first end and a second end of the guiding slot, respectively.

In an embodiment, the position-limiting mechanism further includes a fixing structure, and the fixing structure is penetrated through the guiding slot. The image pickup device is fixed by a first end of the fixing structure. By driving a second end of the fixing structure, the fixing structure is moved along the guiding slot.

In an embodiment, the position-limiting mechanism further includes an electronic driving element for driving the second end of the fixing structure, so that the fixing structure is moved along the guiding slot.

In an embodiment, the position-limiting mechanism further includes a transmission belt. The transmission belt is connected with the electronic driving element and the second end of the fixing structure. As the transmission belt is driven to be moved by the electronic driving element, the fixing structure is synchronously moved along the guiding slot.

In an embodiment, the second end of the fixing structure is manually driven by a user.

In an embodiment, the guiding slot is an arc-shaped slot and a linear slot.

In an embodiment, the position-limiting mechanism at least includes a first fixing hole and a second fixing hole. The image pickup device is accommodated within the first fixing hole or the second fixing hole. When the image pickup device is accommodated within the first fixing hole, the image pickup device is fixed at the first shooting position. When the image pickup device is accommodated within the second fixing hole, the image pickup device is fixed at the second shooting position.

In an embodiment, the desktop three-dimensional image scanner further includes a supporting stand. The supporting stand is connected between the placement platform and the position-limiting mechanism. The image pickup device is fixed by an end of the position-limiting mechanism. When the supporting stand is rotated by an angle, the image pickup device is moved from the first shooting position to the second shooting position.

In an embodiment, the position-limiting mechanism further includes an electronic driving element for driving rotation of the supporting stand by the angle.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side view illustrating a conventional desktop three-dimensional image scanner;

FIG. 2 is a schematic front view illustrating the conventional desktop three-dimensional image scanner of FIG. 1 and taken along a viewpoint V1;

FIG. 3 is a schematic side view illustrating a desktop three-dimensional image scanner according to a first embodiment of the present invention;

FIG. 4 is a schematic perspective view illustrating a position-limiting mechanism of the desktop three-dimensional image scanner of FIG. 3;

FIG. 5 schematically illustrates the shooting zone of the image pickup device of the desktop three-dimensional image scanner of FIG. 3;

FIG. 6 is a schematic perspective view illustrating a position-limiting mechanism of a desktop three-dimensional image scanner according to a second embodiment of the present invention;

FIG. 7 is a schematic perspective view illustrating a position-limiting mechanism of a desktop three-dimensional image scanner according to a third embodiment of the present invention; and

FIG. 8 is a schematic side view illustrating a desktop three-dimensional image scanner according to a fourth embodiment of the present invention.

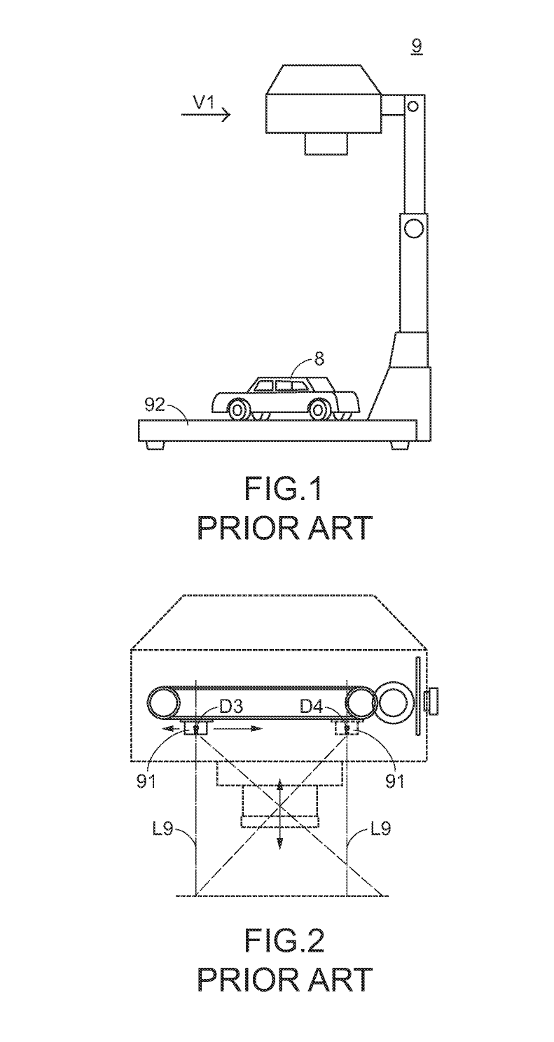

### DETAILED DESCRIPTION OF THE PREFERRED EMBODIMENT

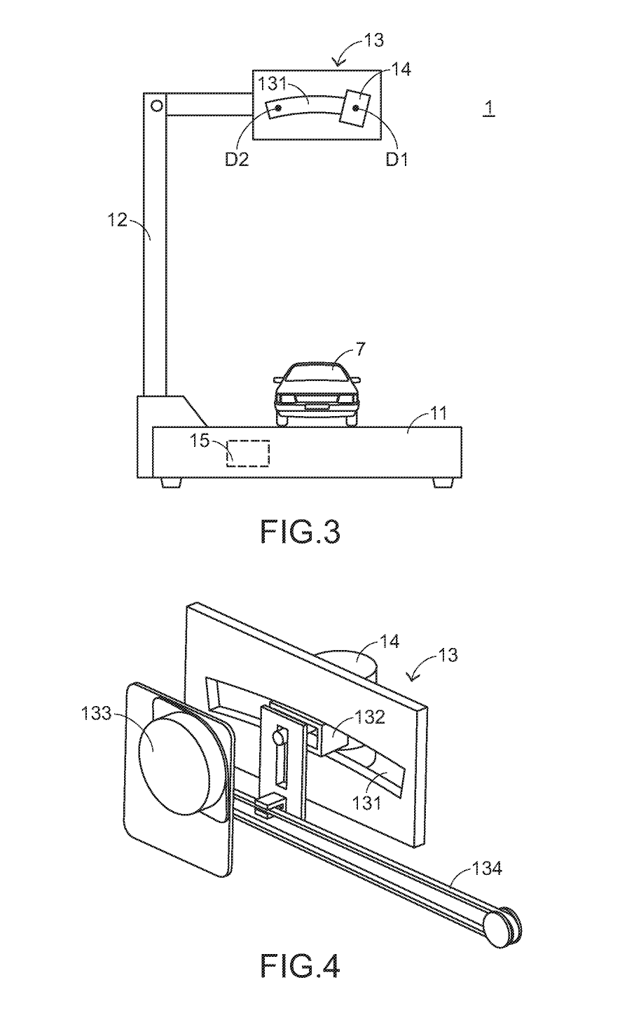

FIG. 3 is a schematic side view illustrating a desktop three-dimensional image scanner according to a first embodiment of the present invention. FIG. 4 is a schematic perspective view illustrating a position-limiting mechanism of the desktop three-dimensional image scanner of FIG. 3. Please refer to FIGS. 3 and 4. The desktop three-dimensional image scanner 1 comprises a placement platform 11, a supporting stand 12, a position-limiting mechanism 13, an image pickup device 14, and an image processing unit 15. An object 7 to be shot is placed on the placement platform 11. For example, the object 7 is a car model. The supporting stand 12 is connected between the placement platform 11 and the position-limiting mechanism 13 for supporting the position-limiting mechanism 13, so that the position-limiting mechanism 13 is located over the placement platform 11. The image processing unit 15 is a software component, a firmware component or a hardware component that is installed in the placement platform 11. In addition, the image processing unit 15 is in communication with the image pickup device 14. The position of the image processing unit 15 is presented herein for purpose of illustration and description only. It is noted that the position of the image processing unit 15 may be varied according to the practical requirements. For example, the image processing unit 15 may be installed in the image pickup device 14 or installed on the position-limiting mechanism 13. Alternatively, in some other embodiments, the image processing unit 15 may be installed in an electronic device (not shown), which is electrically connected with the desktop three-dimensional image scanner 1.

Furthermore, the position-limiting mechanism 13 comprises a guiding slot 131 and a fixing structure 132. The fixing structure 132 is penetrated through the guiding slot 131. A first end of the fixing structure 132 is used for accommodating and fixing the image pickup device 14. By driving a second end of the fixing structure 132, the fixing structure 132 may be moved along the guiding slot 131. In this embodiment, the guiding slot 131 is an arc-shaped slot. When the fixing structure 132 is located at a first end of the guiding slot 131, the image pickup device 14 is located at a first shooting position D1. When the fixing structure 132 is driven to be moved to a second end of the guiding slot 131 along the guiding slot 131, the image pickup device 14 is located at a second shooting position D2.

More preferably, the position-limiting mechanism 13 further comprises an electronic driving element 133 (e.g. a motor) and a transmission belt 134. The transmission belt 134 is connected with the electronic driving element 133 and the second end of the fixing structure 132. As the transmission belt 134 is driven to be moved by the electronic driving element 133, the fixing structure 132 is synchronously moved between the first end and the second end of the guiding slot 131. The way of driving movement of the fixing structure 132 by the electronic driving element 133 is presented herein for purpose of illustration and description only. Alternatively, in some other embodiments, the fixing structure 132 may be manually moved between the first end and the second end of the guiding slot 131 by the user.

FIG. 5 schematically illustrates the shooting zone of the image pickup device of the desktop three-dimensional image scanner of FIG. 3. In a case that the image pickup device 14 is located at the first shooting position D1, the optical axis is denoted as a solid line L1. Under this circumstance, the shooting zone is in the range between two dotted lines L2 and L3. When the image pickup device 14 is located at the first shooting position D1 to shoot the object 7, a first planar image is acquired. In a case that the image pickup device 14 is located at the second shooting position D2, the optical axis is denoted as a solid line L4. Under this circumstance, the shooting zone is in the range between two dotted lines L5 and L6. When the image pickup device 14 is located at the second shooting position D2 to shoot the object 7, a second planar image is acquired.

Since the average distance between two human eyes is about 65 millimeters, the spacing distance between the first shooting position D1 and the second shooting position D2 is designed to be in the range between 6 and 70 millimeters. Moreover, the included angle between the optical axis L1 and the optical axis L4 is designed to be in the range between 1 and 30 degrees. Consequently, after the data of the first planar image and the second planar image are received and processed by the image processing unit 15, a humanoid vision-based three-dimensional image of the object 7 within a specified viewing angle range is produced.

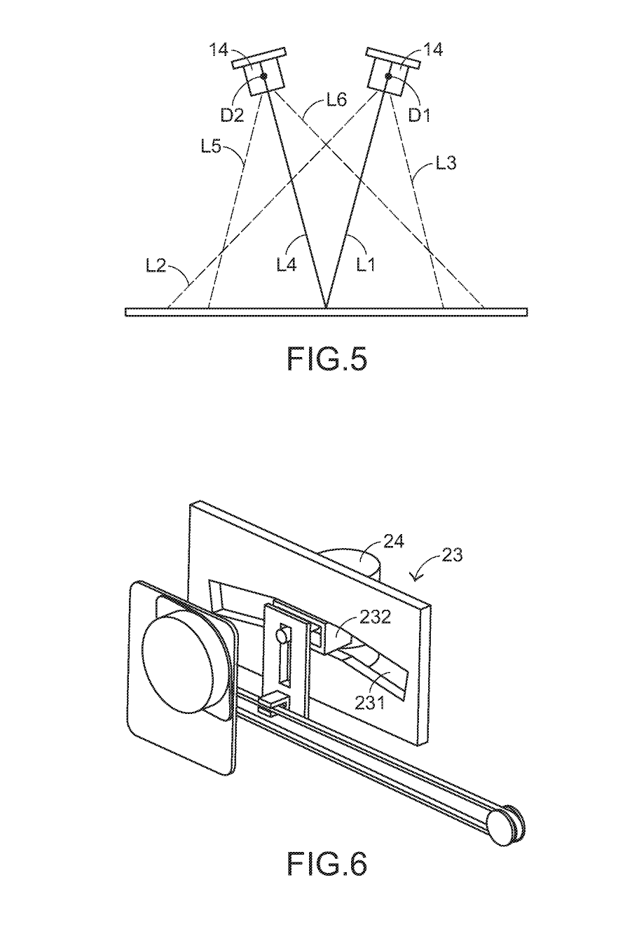

FIG. 6 is a schematic perspective view illustrating a position-limiting mechanism of a desktop three-dimensional image scanner according to a second embodiment of the present invention. Except that the guiding slot 231 of the position-limiting mechanism 23 of the second embodiment is a linear slot, the configurations of the position-limiting mechanism of the second embodiment are similar to those of the first embodiment, and are not redundantly described herein. Similarly, when the fixing structure 232 is located at the first end of the guiding slot 231, the image pickup device 24 is located at the first shooting position. When the fixing structure 232 is driven to be moved to the second end of the guiding slot 231 along the guiding slot 231, the image pickup device 24 is located at the second shooting position.

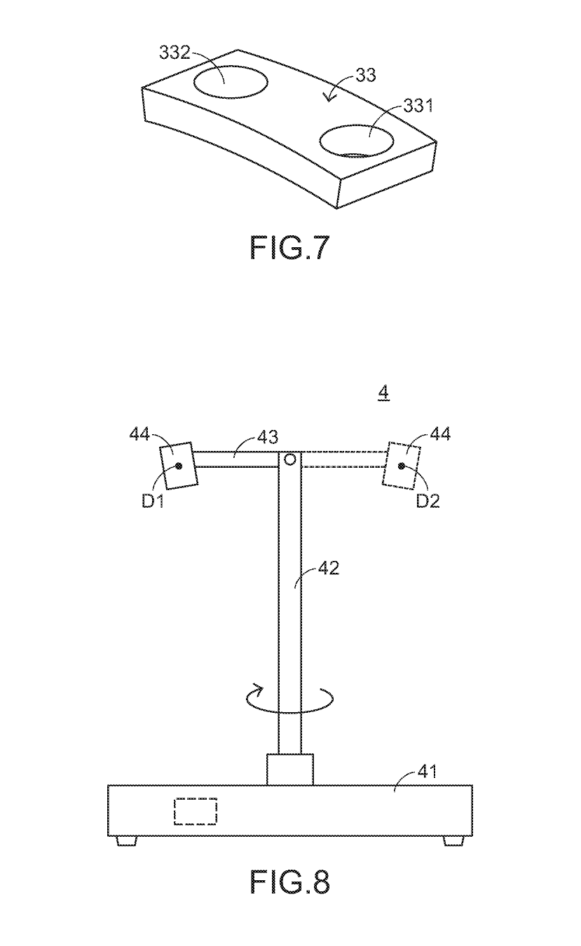

FIG. 7 is a schematic perspective view illustrating a position-limiting mechanism of a desktop three-dimensional image scanner according to a third embodiment of the present invention. Except that the position-limiting mechanism 33 of the third embodiment is a curvy plate with a first fixing hole 331 and a second fixing hole 332, the configurations of the position-limiting mechanism of the third embodiment are similar to those of the first embodiment, and are not redundantly described herein. The first fixing hole 331 and the second fixing hole 332 are used for accommodating the image pickup device (not shown). When the image pickup device is accommodated within the first fixing hole 331, the image pickup device is located at the first shooting position. When the image pickup device is accommodated within the second fixing hole 332, the image pickup device is located at the second shooting position. Moreover, the image pickup device may be manually placed within the first fixing hole 331 or the second fixing hole 332 by the user.

FIG. 8 is a schematic side view illustrating a desktop three-dimensional image scanner according to a fourth embodiment of the present invention. Except for the following items, the configurations of the position-limiting mechanism of the fourth embodiment are similar to those of the first embodiment, and are not redundantly described herein. In this embodiment, the three-dimensional image scanner 4 comprises a placement platform 41, a supporting stand 42, a position-limiting mechanism 43, and an image pickup device 44. A bottom end of the supporting stand 42 is arranged between two sides of the placement platform 41. Moreover, the supporting stand 42 is rotatable relative to the placement platform 41. A top end of the supporting stand 42 is connected with the position-limiting mechanism 43. Moreover, the image pickup device 44 is fixed at an end of the position-limiting mechanism 43. When the supporting stand 42 is rotated by an angle, the image pickup device 44 is moved from a first shooting position D1 to a second shooting position D2. As shown in FIG. 8, the dotted region denotes the second shooting position D2 of the image pickup device 44. In an embodiment, the supporting stand 42 may be manually rotated by the user. Alternatively, in some other embodiments, the supporting stand 42 may be rotated in response to a driving force provided by an electronic driving element (not shown).

From the above descriptions, the desktop three-dimensional image scanner of the present invention can be operated more easily and conveniently. Moreover, due to a smaller operating space, the desktop three-dimensional image scanner of the present invention may be easily placed on a desk (e.g. an office desk) and feasible for special applications (e.g. experiments or inspections).

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A desktop three-dimensional image scanner, comprising:
an image pickup device located over an object for shooting said object at a first shooting position and a second shooting position, thereby acquiring a first planar image and a second planar image, respectively; and
a position-limiting mechanism for accommodating said image pickup device and fixing said image pickup device at said first shooting position or said second shooting position,
wherein a humanoid vision-based three-dimensional image of said object is produced according to said first planar image and said second planar image, wherein a spacing distance between said first shooting position and said second shooting position is in a range between 6 and 70 millimeters, and an included angle between an optical axis of said image pickup device at said first shooting position and said optical axis of said image pickup device at said second shooting position is in a range between 1 and 30 degrees.

2. The desktop three-dimensional image scanner according to claim 1, further comprising an image processing unit for processing said first planar image and said second planar image, thereby producing said humanoid vision-based three-dimensional image.

3. The desktop three-dimensional image scanner according to claim 1, wherein said desktop three-dimensional image scanner is in communication with an electronic device, wherein said electronic device comprises an image processing unit for processing said first planar image and said second planar image, thereby producing said humanoid vision-based three-dimensional image.

4. The desktop three-dimensional image scanner according to claim 1, further comprising a placement platform, wherein said object is placed on said placement platform.

5. The desktop three-dimensional image scanner according to claim 4, further comprising a supporting stand, wherein said supporting stand is connected between said placement platform and said position-limiting mechanism.

6. The desktop three-dimensional image scanner according to claim 1, wherein said position-limiting mechanism comprises a guiding slot, wherein said first shooting position and said second shooting position are located at a first end and a second end of said guiding slot, respectively.

7. The desktop three-dimensional image scanner according to claim 6, wherein said position-limiting mechanism further comprises a fixing structure, and said fixing structure is penetrated through said guiding slot, wherein said image pickup device is fixed by a first end of said fixing structure, wherein by driving a second end of said fixing structure, said fixing structure is moved along said guiding slot.

8. The desktop three-dimensional image scanner according to claim 7, wherein said position-limiting mechanism further comprises an electronic driving element for driving said second end of said fixing structure, so that said fixing structure is moved along said guiding slot.

9. The desktop three-dimensional image scanner according to claim 8, wherein said position-limiting mechanism further comprises a transmission belt, wherein said transmission belt is connected with said electronic driving element and said second end of said fixing structure, wherein as said transmission belt is driven to be moved by said electronic driving element, said fixing structure is synchronously moved along said guiding slot.

10. The desktop three-dimensional image scanner according to claim 7, wherein said second end of said fixing structure is manually driven by a user.

11. The desktop three-dimensional image scanner according to claim 6, wherein said guiding slot is an arc-shaped slot and a linear slot.

12. The desktop three-dimensional image scanner according to claim 1, wherein said position-limiting mechanism at least comprises a first fixing hole and a second fixing hole, wherein said image pickup device is accommodated within said first fixing hole or said second fixing hole, wherein when said image pickup device is accommodated within said first fixing hole, said image pickup device is fixed at said first shooting position, wherein when said image pickup device is accommodated within said second fixing hole, said image pickup device is fixed at said second shooting position.

13. The desktop three-dimensional image scanner according to claim 1, further comprising a supporting stand, wherein said supporting stand is connected between said placement platform and said position-limiting mechanism, and said image pickup device is fixed by an end of said position-limiting mechanism, wherein when said supporting stand is rotated by an angle, said image pickup device is moved from said first shooting position to said second shooting position.

14. The desktop three-dimensional image scanner according to claim 13, wherein said position-limiting mechanism further comprises an electronic driving element for driving rotation of said supporting stand by said angle.
